(19) United States
(12) Patent Application Publication
(10) Pub. No.: US 2005/0262481 A1
(43) Pub. Date: Nov. 24, 2005

(54) Customizable toolbar creation and control

(76) Inventor: Julia Claire Coulson, Sandton (ZA)

Correspondence Address: PRICE & ADAMS, P.C., 4135 BROWNSVILLE ROAD, P.O. BOX 98127, PITTSBURGH, PA, 15227-0127, US

(21) Appl. No.: 10/954,918

(22) Filed: Sep. 30, 2004

(30) Foreign Application Priority Data
Sep. 30, 2003 (ZA) 2003/7595

(51) Int. Cl. G06F 9/44

(52) U.S. Cl. 717/120; 717/171

(57) ABSTRACT

A control computer is accessed to execute a toolbar building program to customize a standard toolbar. The control computer displays a builder form to receive input to define a customized function list for the toolbar. The builder form transfers the function list to the program to convert the function list into a customized toolbar. The toolbar is stored in a data structure having an XML file with at least one folder and source code for performing data processing. The data structure resides on a computer system for distribution to client computers having software applications that utilize the customized toolbar.

### BACKGROUND OF THE INVENTION

1. Field of the Invention

This invention relates to a customizable toolbar for controlled distribution and use, and more particularly, to an apparatus and method for creating and distributing a customizable toolbar to a plurality of software applications residing on client computers.

2. Description of the Prior Art

User interfaces have increased in complexity and “user-friendliness” since the early main frame computers through a combination of hardware and software developments. When main frame computers first became popular, key cards and printouts composed the user interface. The user was required to enter data on a key card to input the data into the computer. The user had to physically punch holes in the key cards in a particular way. Thus, if the user punched a hole in the wrong place then the user would have to reenter all the information on a new key card. This user interface may have been relatively user friendly at that time but is not considered so today.

The first big breakthrough in “user-friendliness” with regards to hardware was the combination of the display and keyboard. The keyboard and display allowed a user to see the data in a recognizable format as it was being entered into the computer. Errors could then be detected and corrected much more quickly. The software program user interfaces were slow to take advantage of the keyboard and display combination however. For example, some of the original user interfaces that developed were add-ons to the earlier key card interfaces such that a user had to enter information in exactly the same format as he did for the key cards, but the information was typed at specific coordinates on the display rather than being holes punched in specific places on a key card. Still, if the user made an error typing the data into a specific location, e.g. typed the information one character to the left or one character to the right of where it was supposed to be typed, the computer rejected the entry and required the user to reenter the information.

The software finally began to catch up to the keyboard and display hardware combination with the use of a command line and script window. The command line allowed the user to enter commands which initiated a specific or a sequence of specific software program functions. The script window returned the results of a command to a user immediately and allowed the user to review prior actions by scrolling the commands and results upward as new commands and results were displayed. In addition, the “user-friendliness” of data entry was improved by allowing users to enter information one field at a time, informing the user when a field was entered in an incorrect format, and requiring the user to reenter only the fields, or characters within a field that were wrong rather than making the user reenter the entire data record.

The second significant break through in regard to computer hardware for user interfaces was the mouse. The mouse allows the user to point at something on the display and select it by pressing a button on the mouse. The simultaneous response of the software was command menu systems. The command menu system in combination with the mouse, command line, keyboard and display, allowed users to select from a categorized menu of commands, the command the user desired to execute. The command menu systems were primarily character representations of software program functions. Later, graphical user interfaces (GUI's) were developed. GUI's, still in use today, depict functions with graphics. The graphics give the software programmer the opportunity to fit more software program functions on a display, as well as allow the user to scan through the command functions more quickly, since the graphic or pictorial descriptions can be more compact and more descriptive than their character counterparts.

U.S. Pat. No. 6,600,498 discloses a method, means, and device for acquiring user input to customize a GUI within a computer.

GUI's seem to offer the best user interfaces to date when combined with the menu command system in operating systems such as MacOS™ and Windows™ and in software applications programs. The combined menu command system and GUI, however, still have a shortfall. The increasing complexity of software programs along with the increasing diversity of projects for which the users use software programs and the proliferation of computer users has made a well-tailored user interface, up until now, practically impossible. In addition, programmers writing software applications are including an enormous number of software program functions, creating a default menu command system and toolbar, and allowing the user to customize the user interface by allowing the user to select the functions that are to be available in the menu command system and toolbar.

Toolbars are arrangements of horizontal or vertical rows of iconic images, buttons, or prompts that appear within a GUI. Toolbars are part of a control section of an application, such as a word processing program or an Internet browser that is displayed on a computer screen. Toolbars provide users with access to certain desktop or application functions by selecting an icon, button, or prompt from a dropdown menu that is displayed on the GUI. U.S. Patent No. 5,790,435 discloses a toolbar that is used in an electrical circuit timing analysis and verification computer program.

U.S. patent Publication No. 2003/0204637 discloses a compilable program generator that utilizes a toolbar. The program generator includes a GUI that has a document creator, a process flow chart, a report composer, and a manual selector. The program generator generates source code. The program generator includes a layout toolbar.

U.S. patent Publication No. 2002/0163544 discloses a customizable toolbar for use on a personal digital assistant (PDA). The toolbar includes a plurality of polysemous symbols. Each symbol corresponds to a software application or a function within a software application, allowing the user to navigate through a plurality of applications, between applications, or within a single application. Each software application or function is associated with source code. The toolbar is intended for use on a single PDA, which can be used to access the Internet, an intranet, or similar type of network.

U.S. Pat. No. 6,493,868 discloses an integrated code development tool that uses a toolbar. The code development tool builds software applications. The code development tool includes an assembler that translates assembly language source code into machine language object files. The code development tool utilizes toolbars.

U.S. Pat. No. 6,093,215 discloses a component customization and distribution system in an object oriented environment. The component includes a method and apparatus for building templates. The system includes various base applications, such as file viewers, spreadsheets, and the like. The templates include toolbars.

U.S. pat. Publication No. 2002/0149618 discloses a collaborative work space object model, QuickPlace, having a place consisting of rooms created by users to interact with one another through a client browser. The collaborative space object model allows users to interact over the Internet or over an intranet. A QuickPlace master directory resides on a server that includes an operating system that includes a toolbar. The space object model includes a place object that holds skins, forms, and files. Access to the place object is protected by a security and authentication model. The process for building the collaborative work space environment uses forms.

Word processing applications, such as MS Word, allow users to customize or personalize toolbars to a certain extent. However, the toolbars must be customized within predefined limitations. The user must have specialized programming knowledge to make extensive changes to the toolbar, which is outside of the scope of the average user.

The MS Word toolbars are stored in the Normal.dot file, which can be copied to the MS Word start-up folder on individual workstations. The particular workstations can display the toolbar when the MS Word application is executed. However, the Normal.dot file must be copied to every workstation every time that the toolbar is altered in such systems. Such an arrangement is adequate for toolbars that include a few files, but complex, customizable toolbars are unwieldy due to the substantial number of custom macros that must be added.

A further problem arises in computer systems or networks that include a plurality of computer users. Individual users may take advantage of the limited options for customizing the toolbars and customize their client computer applications. These individualized, customized client computer application toolbars may not be uniform within a given system. The customized toolbars can be used to create customized documents that do not have the common “look and feel” of the overall organization.

In addition, manual modification of toolbars is a tedious and time consuming process. The modified toolbars must be installed on or copied to each computer in a system. For MS Word users, each time the master template file or normal.dot file is changed and copied to a new computer, the file overrides the existing settings on the toolbar.

It has also been found that copying the master template file or normal.dot file from MS Word Version 95 to MS Word Version 97 or above is problematic because the toolbar must be adjusted to run on the later versions of MS Word. This creates difficulty in systems or environments where multiple versions of MS Word are operated.

The code must also be stored within a word template on each computer. The storage of the code in this manner utilizes memory. The code must also be suitably protected from viewing, changing, or deleting by ordinary users. Even with suitable protection, macro names, which can be used to determine which toolbar procedures are macro-driven, are available for viewing. This information can be used to view, change, and delete the styles and autotext entries that are linked to the toolbar. The autotext entries require considerable memory.

A final problem with existing systems is the absence of adequate, customizable toolbars for notebook computers that can be used when the notebook computer is not connected to a network. The existing functions for replicating toolbars and related files to notebook computers are extremely complicated and not practical. Accordingly, there is a need for an apparatus and method for creating and distributing a uniform, customizable toolbar to a plurality of software applications residing on client computers.

### SUMMARY OF THE INVENTION

In accordance with the present invention there is provided a system for customizing a software application that includes a customizable toolbar having a source code program with a plurality of means for processing data and a folder for storing said data processing means. A hub has a file for storing the customizable toolbar and a memory storage device for storing said file thereon. The hub is connected to a plurality of remote clients. Each remote client has a software application residing thereon. Each software application has the ability to interface with the toolbar. The hub distributes the toolbar to the plurality of remote clients so that each of the client software applications accesses the toolbar.

Further in accordance with the present invention, there is provided a method for providing custom toolbars to remote clients. A toolbar building application for converting a standard toolbar into custom toolbars is accessed. The toolbar building application is executed to create a custom toolbar for storing in a file residing on a control computer. The control computer is connected to a client computer having a software application for utilizing the custom toolbar residing thereon. The custom toolbar is transferred from the control computer to the client computer so that the software application includes the custom toolbar. The software application is executed to display the custom toolbar on the client computer so that the software application utilizes the custom toolbar.

Further in accordance with the present invention, there is provided a method for building a customized toolbar for providing to remote users. A control computer having a memory device is accessed to execute a toolbar building program and a standard toolbar residing in the control computer memory device. A builder form is displayed to receive input to define a function list for amending the standard toolbar to form a customized toolbar. The function list is transferred from the builder form to the toolbar building program to interface the function list with the toolbar building program. The toolbar building program is executed to convert the function list and standard toolbar into the customized toolbar. The customized toolbar is stored in the control computer memory device.

Accordingly, a principal object of the present invention is provide a toolbar for controlled distribution and use within a computer system that includes a plurality of computers for respective users.

Another object of the present invention is to provide a customized toolbar stored at a control location for automatic transfer to a specified software application upon execution of that application.

Another object of the present invention is to provide a method for building a customized toolbar.

A further object of the present invention is to provide a program for controlling access to a customized toolbar for alteration or modification by an authorized administrator.

A further object of the present invention is to provide a customized toolbar that resides on a centralized, control computer for distribution in a computer system.

These and other objects of the present invention will be more completely described and disclosed in the following specification, accompanying drawings, and appended claims.

### BRIEF DESCRIPTION OF THE DRAWINGS

FIG. 1 is a screen shot, illustrating a MS Word software application that has a pair of customized toolbars.

FIG. 2 is a diagrammatic illustration of a system for creating and distributing a customized toolbar to a word processing software application.

FIG. 3 is a block diagram, illustrating a system for creating and distributing a customized toolbar to a plurality of users.

FIG. 4 is a flow chart, illustrating the steps for creating or modifying a customized toolbar for use within a computer system.

FIG. 5 is a screen shot illustrating a toolbar building application.

FIG. 6 is a screen shot, illustrating the use of the toolbar building application to amend XML file that includes a customized toolbar.

FIG. 7 is a screen shot, illustrating the insertion of a symbol into the toolbar that is stored in the XML file.

FIG. 8 is a screen shot, illustrating the use of the toolbar building application to amend the toolbar to identify the descriptive symbol name that will be displayed in a balloon box on the symbols drop down menu or the floating symbols toolbar when the mouse pointer rests on the related symbol from FIG. 7.

FIG. 9 is a screen shot, illustrating the use of a customized toolbar within a MS Word application to obtain a drop-down list of document templates and a customized toolbar having the inserted symbol from FIG. 7.

FIG. 10 is a screen shot, illustrating the use of a customized toolbar function to create a standardized facsimile document.

FIG. 11 is a screen shot, illustrating a standardized letter document.

FIG. 12 is a screen shot, illustrating the use of a customized toolbar within a MS Word application to obtain drop-down lists of departmental forms.

FIG. 13 is a screen shot, illustrating the use of a customized toolbar to view a departmental form.

FIG. 14 is a portion of a screen shot, illustrating a toolbar button for a datalog function.

FIG. 15 is a screen shot, illustrating a window for the datalog function shown in FIG. 14.

### DESCRIPTION OF THE PREFERRED EMBODIMENTS

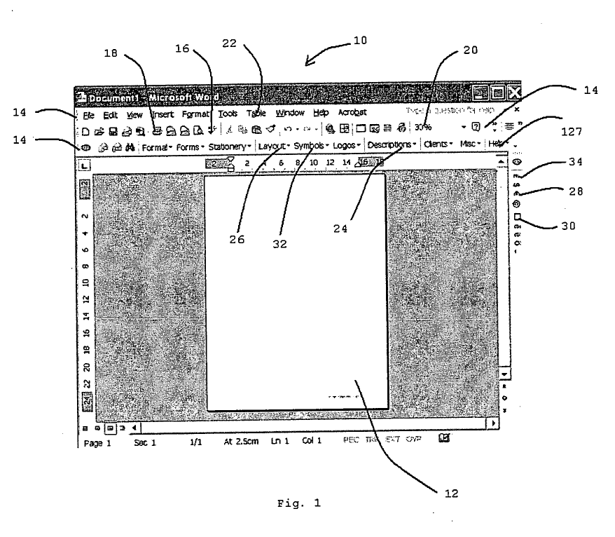

The present invention is directed to a method and apparatus for creating and distributing a customizable toolbar employed for use in a software application. Referring now to the drawings, and particularly to FIG. 1, there is illustrated a word processing software application window 10. The window 10 includes a document 12 and a plurality of standard toolbars 14 having a plurality of buttons 16, icons 18, symbols 20, and labels 22. The standard toolbars 14 are used to format or otherwise process the document 12.

The window 10 also includes a customized toolbar 24 having a plurality of buttons 26 and a customized toolbar 28 having a plurality of buttons 30. Each button 26 includes a label 32 for executing a corresponding function, prompt, or application. Each button 30 includes a symbol 34 for executing a corresponding function, prompt, or application. While the customized toolbars 24, 28 are shown with buttons 26, 30, labels 32, and symbols 34, the customized toolbars 24, 28 are not limited to such indicia or similar graphical representations. The customized toolbars 24, 28 include any suitable button, icon, symbol, label, alphanumeric character, group of characters, or similar indicia or graphical representations.

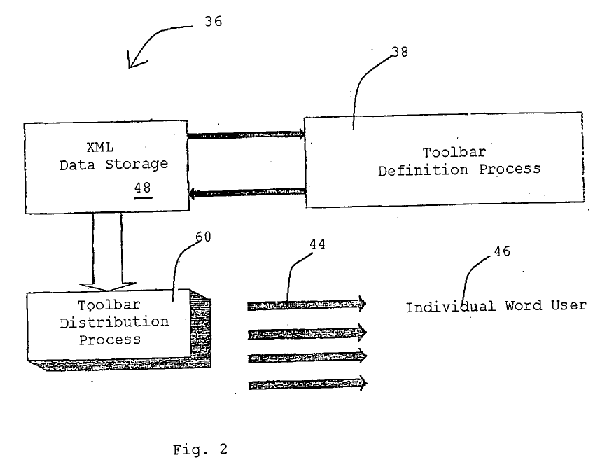

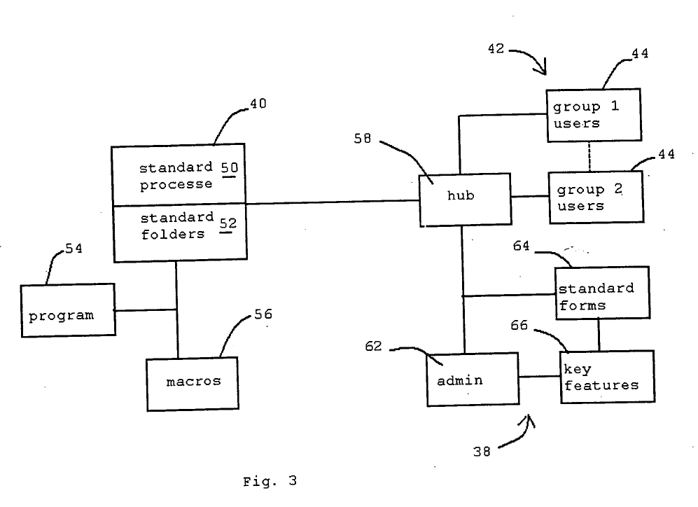

Now referring to FIGS. 2 and 3, there is shown an apparatus 36 for creating and distributing the customized toolbars 24, 28 shown in FIG. 1. The toolbars 24, 28 are created using a toolbar building application 38. The toolbars 24, 28 are stored in a suitable data structure 40 and are distributed through a computer system 42 to a plurality of clients 44. Each client 44 has a software application 46 that uses either toolbar 24 or toolbar 28 or both.

As shown in FIGS. 2-3, the data structure 40 includes a XML protected file 48 which contains source code for a program 50 and a folder 52. The source code uses standard integrated processes or similar data processing means 54 to provide executable instructions for producing data processing products 56, such as applications, functions, standard templates, forms, macros, symbols, auto signatures, descriptions, or similar products. The data processing products 56 correspond to indicia or graphical representations for the customized toolbars 24, 28 shown in FIG. 1. The folder 52 contains the data processing means 54 that produce the data processing products 56.

The data structure 40, XML file 48, folder 52, and data processing means 54 reside on a suitable memory storage device (not shown) for transfer to the computer system 42. In one exemplary embodiment, the data structure 40, XML file 48, folder 52 and data processing means 54 are stored on a compact disc for installation on a stand-alone personal computer or server that functions as a hub 58 for the computer system 42. The hub 58 includes a memory storage device 60 for storing the data structure 40, XML file 48, folder 52, and data processing means 54.

As shown in FIGS. 1-3, the toolbar building application 38 displays a toolbar builder form 64. The toolbar builder form 64 is a standardized form that operates as a data input sheet for determining the specifications for the toolbars 24, 28. The toolbar building application 38 reads information that it receives from the program 50 and translates the information into customized toolbars 24, 28. The toolbars 24, 28 are controlled by the computer system administration application or module 62.

The creation of the toolbars 24, 28 involves interaction between the administration application 62, and the client software applications, such as MS Word. In the preferred embodiment, the administration application 62 and standardized form 64 are installed on the hub 58, which is a standalone computer or a network server. The hub 58 and the administration application control the creation or execution of the toolbars 24, 28. Each time one of the clients 44 runs an application program, the toolbar data structure 40 is read from the hub 58 to execute on the client computer.

The hub 58 provides the clients 44 with access to the data structure 40, XML file 48, folder 52, and data processing means 54 through the computer system 42. Each client 44 includes a standalone or networked computer, such as a desktop computer, laptop computer, personal digital assistant (PDA), network terminal, or other similar device. The client computers have the ability to connect to the computer system 42. The client computers include memory devices for storing the toolbars 24, 28, display devices for displaying the toolbars 24, 28, and an input-output interface device, such as a keyboard or mouse, for facilitating access to the toolbars 24, 28.

The client computers have the ability to run software applications, such as MS Word. In the preferred embodiment, the client computers are automatically linked to the hub 58, so that the hub 58 executes the XML file 48 containing the toolbars 24, 28 upon execution of the applications residing on the client computers. The XML file 58 reads the folder 52 into the client computer to display the toolbars 24, 28 on a display device or screen on the client computer. The toolbars 24, 28 are automatically sent to the client computers and the client 44 cannot substitute an alternative toolbar for the customized toolbar 24, 28, nor is the client 44 able to amend the toolbars 24, 28.

The computer system 42 and hub 58 are configured to distribute the toolbars 24, 28 to a single user or to multiple users through direct connections, intranet connections, Internet connections, local area network (LAN) connections, wide are network (WAN) connections, or any other similar network connection. The embodiment shown in FIG. 2 includes a computer system 42 having connections to four clients 44. However, the number of clients 44 is not critical. In the preferred embodiment, the computer system 42 and hub 58 are password protected and include other security means to prevent unauthorized access by unlicensed users.

The computer system 42 is also configured to accommodate client computers, such as laptops, that are temporarily connected to the hub 58. The laptops include a sync button (not shown) on one of the toolbars 24, 28, so that clicking on the sync button executes a function to copy the toolbars 24, 28 and the associated files replicating the toolbars 24, 28 on the laptops. The laptops are synchronized, at a remote site, to download the toolbars 24, 28 and links from the hub 58. The toolbars 24, 28 are available to the clients 44 after the client computers are disengaged from the computer system 42.

The toolbars 24, 28 are created, defined, amended, or otherwise customized by the toolbar building application 38. The toolbars 24, 28 are controlled by a control means or administrator 62 that restricts access the program 50. The administrator 62 includes a password protection routine that receives input in the form of an authorizing code, personal identity number (PIN), or similar key from authorized personnel before providing access to the program 50 to modify the toolbars 24, 28.

The toolbar builder form 62 is produced by any appropriate language, such as Visual Basic which interfaces with MS Word. The toolbar building application 38 receives input from a toolbar builder form 64 to write key features 66 into the program 50 to personalize and transform an existing or basic toolbar structure into customized toolbars 24, 28, shown in FIG. 1, for producing the data processing products 56. The toolbars 24, 28 are constructed and stored in the XML file 48.

The control means 62 distributes the toolbars 24, 28 to the clients 44 on a controlled basis. Each client 44 that is licensed to use the toolbars 24, 28 has the ability to display the toolbars 24, 28. The toolbars 24, 28 are only available to clients 44 who have user licenses.

The toolbar building application 38 is a suitable software application, macro, applet, or other similar device. The toolbar building application 38 creates data processing means 54 for storage in the XML file 58. Since the data processing means 54 are stored in the external XML file 58, rather than in the user software application, the clients 44 are not able to view, copy or change the data processing means 58. Descriptive text, relating to the toolbars 24, 28, is not saved as autotext but, instead, is stored in files which are disc based links and not memory resident. Consequently, the only limit to the number or extent of descriptions is disc size.

Referring to FIGS. 2-4, there is shown the toolbar building process 68, which differs from the MS Word toolbar building process. The toolbar building process 68 utilizes the toolbar building application 38. The toolbar building application 38 is a separate program preferably written in Visual Basic. The toolbar building application 38 operates outside of the user software application, preferably MS Word, but is capable of interfacing with the application to create the toolbar. The toolbar building application 38 is stored in any suitable medium, for example a hard disc or compact disc, and the program code is encapsulated in a single XML protected file 48.

The toolbar building application 38 also includes a function to ensure that the system includes backup files. The toolbar building application 38 flags the appropriate files for saving and makes backup copies of those files. The toolbar building application 38 makes backup copies of those files when the flagged files are accessed by end users.

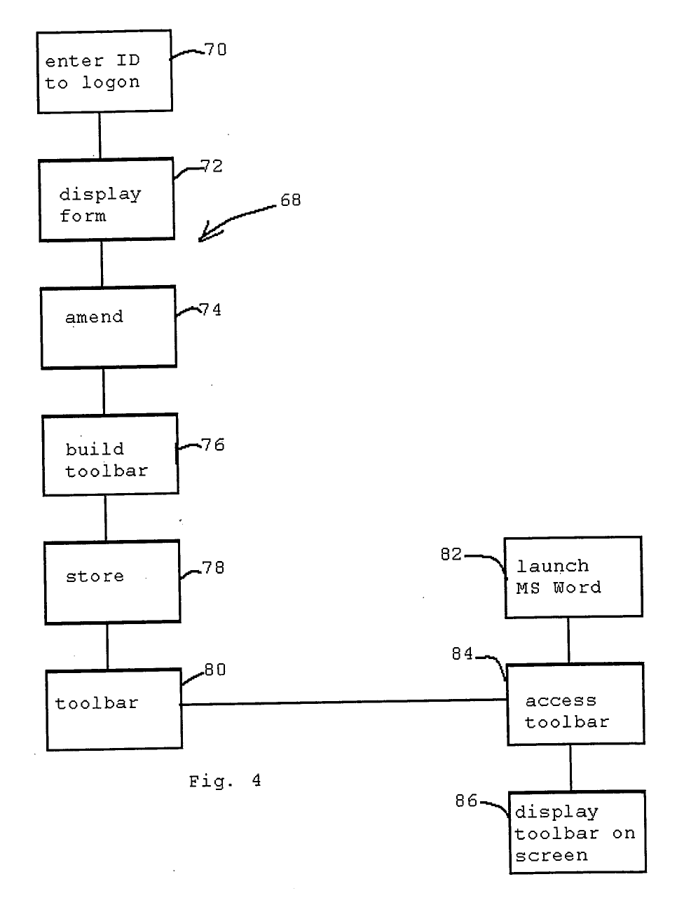

As shown in FIGS. 3-4, the administrator 62 enters an ID and authorization code to perform a logon step 70 to access the program 50. The toolbar builder form 64 is then displayed in a builder displaying step 72 to the administrator 62 to facilitate an amendment step 74 to specify customized toolbar features 66. The features 66 include data processing means 54 for producing data processing products 56. The displaying step 72 includes prompts to obtain input to specify features 66 that are utilized in the user software application. In the preferred embodiment, the data processing means 54 produce uniform data processing products 56 to correspond to the identity of the organization that controls the computer system 42, such as a corporation.

After obtaining the customized toolbar features 66 in the amendment step 74, the toolbar building application 38 performs a building step 76 and a storing step 78 to produce a master toolbar 80. The master toolbar 80 is enhanced, added to, or personalized, at any stage by the administrator 62 according to personal or company requirements. Updated information relating to the master toolbar 80 is stored in the XML file 48 on the hub 58, as shown in FIGS. 2-3.

The hub 58 provides one or more toolbars 80 to one or more clients 44. In one embodiment, the hub 58 provides a single toolbar 80 for a plurality of users. In another embodiment, the hub 58 provides a plurality of customized toolbars 80 to a plurality of clients 44, with each customized toolbar 80 being associated with a specific group of clients 44. In such an embodiment, a first group of users could use a first toolbar, a second group of users could be authorized to use a second toolbar, and so on within a large company.

As shown in FIGS. 3-4, the master toolbar 80 is only available to users via the hub 58. The toolbar 80 is automatically transferred to authorized clients 44 each time the respective user.executes the relevant user software application. Upon execution of the application, the relevant data structure 40 is accessed from the hub 58 for conversion into the toolbar 80 for display on the respective client computer.

The clients 44 access the toolbar 80 by executing a software application residing on their computers in a software application step 82. Upon execution of the application, the administrator 62 restricts access to the toolbar 80 by determining whether a particular client 44 is licensed to use the toolbar 80. Once the administrator 62 determines that the client 44 is licensed for use, the client computer accesses the toolbar 80 in an accessing step 84 and displays the toolbar 84 in a client displaying step 86. In the preferred embodiment, the toolbar 84 is automatically read from the hub 58 and displayed on the licensed user's computer screen.

The toolbar creation and distribution apparatus 36 is used with the software application 46. The software application 46 is a suitable GUI based software application, such as a word processing application, spreadsheet, email authoring application, presentation creation application, web page authoring application, or similar application, that runs on a computer system that uses a suitable operating system. The preferred embodiment is described with reference to its use in a MS Word word-processing environment. However, the invention is applicable to other software applications, such as Microsoft Excel, Microsoft Outlook, Microsoft PowerPoint and Microsoft Access and to any suitable application that uses a toolbar or similar screen display. The preferred operating system is Windows 2000, Windows XP, Windows 2002, or any system that can be used to run Microsoft Office 97 or Microsoft Office 2003.

The toolbar building application 38 and customized toolbars 24, 28 are available on a licensed basis. Clients 44 must register to obtain licenses annually. The toolbar building application 38 controls the registration process. The application 38 provides clients 44 with the ability to increase or decrease the number of licenses, as needed.

The toolbar building application 38 is installed using conventional software installation methods. The typical installation method utilizes a full installation compact disc. Upon installation, the toolbar building application 38 prompts the user to register the program or to run the program in the demonstration mode. The demonstration mode is available for a limited period and for a limited number of users. The application 38 displays a registration window (not shown) during the demonstration mode period to remind the user to register the application 38 or toolbar 80. The application 38 disables itself upon expiration of the demonstration mode period.

The toolbar building application 38 facilitates the registration process by creating a reference code for transmission to a licensing entity (not shown). The application 38 generates a reference code that is specific to the machine that is hosting the application 38. The key code is generated using a combination of the expiration date and the number of license. The licensing entity uses the reference code to generate a key code, so that the key code has a specific relationship to the machine that is hosting the application 38, and to the number of licenses.

The licensing entity transmits the key code for receipt by the toolbar building application 38. The application 38 utilizes the key code to authorize the user to build the toolbars 24, 28 for distribution to the clients 44. Once the key code is keyed into the application 38, the key code can never be used again. The application 38 creates new reference codes for upgrades, which results in the licensing entity creating new key codes. As a result, the key code cannot be used more than once and cannot be used on any other machine.

The registered version of the toolbar building application 38 includes all of the features for building the toolbar 80. The registered version of the application 38 is password protected and does not display the registration window. The registered version of the application 38 also monitors the number of clients 44 that are using the toolbar 80 to prevent clients 44 from exceeding their allocation of licenses.

The toolbar building process 68 provides many advantages over conventional, manual toolbar building methods. The builder form 64 is user friendly and easy to read. The form 64 can be readily used according to specific requirements for a custom toolbar 80. The form 64 interfaces with the user software application and is dependent on administrator input. The toolbar building application 38 utilizes user input to automatically generate the customized toolbar 80 for controlled use by specified clients 44. The toolbar building application 38 substantially automates the toolbar building process to provide faster production of a customized toolbar 80.

The toolbar building process 68 also makes it possible for a corporation or other large organization to present a uniform image. The building process 68 can be monitored and specified, so that the user software applications use customized toolbars 80 to produce documents having uniform fonts, logos, descriptions, headings and the like. The building process 68 restricts clients 44 from producing documents in variance with the uniform image.

The clients 44 are also unable to change the master template. When the clients 44 open a document, a copy of the master file is opened. The clients 44 can change the copy of the master file, unless the master file is protected by the toolbar administrator 62.

The toolbar building process 68 also protects the client 44 from loss of the customized toolbar 80. Since the toolbar 80 is stored on the hub 58, the toolbar 80 can be reinstalled or accessed by the client 44 in the event of a system crash, application crash, or similar event.

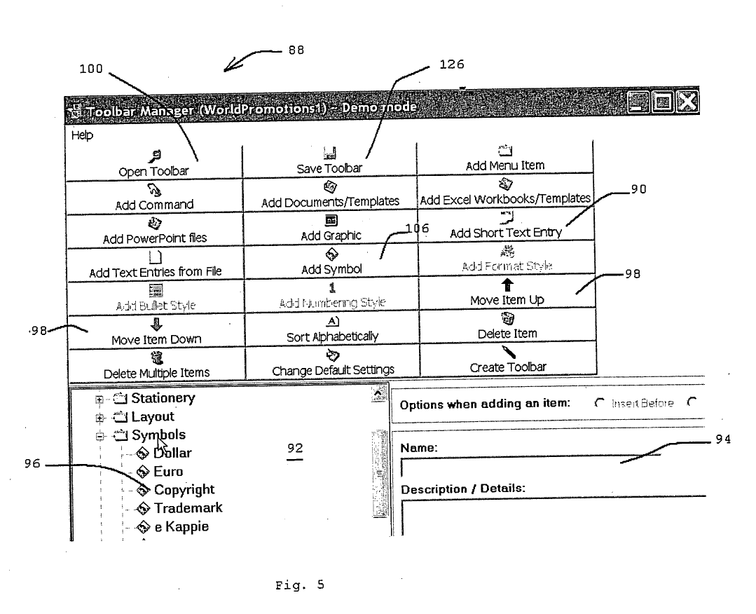

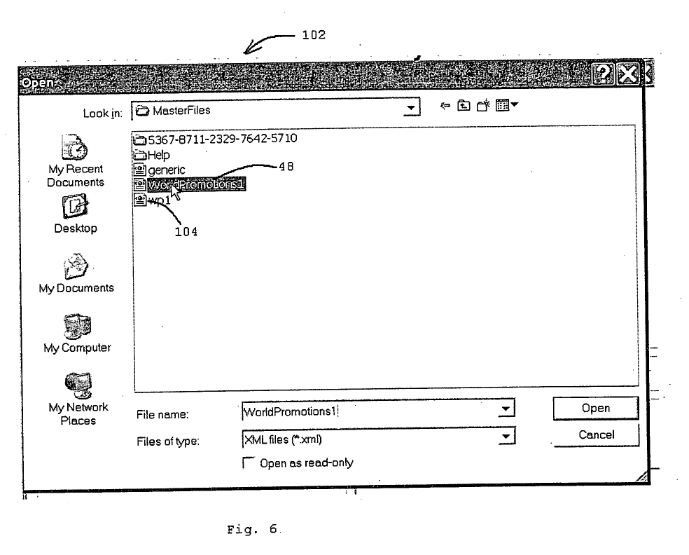

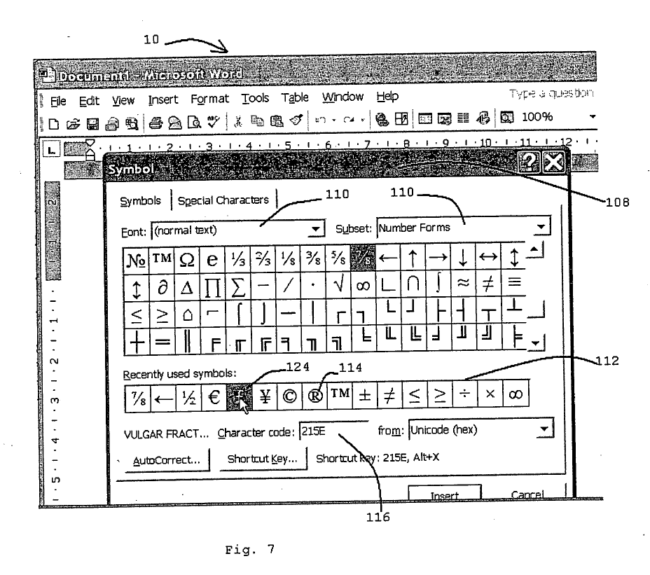

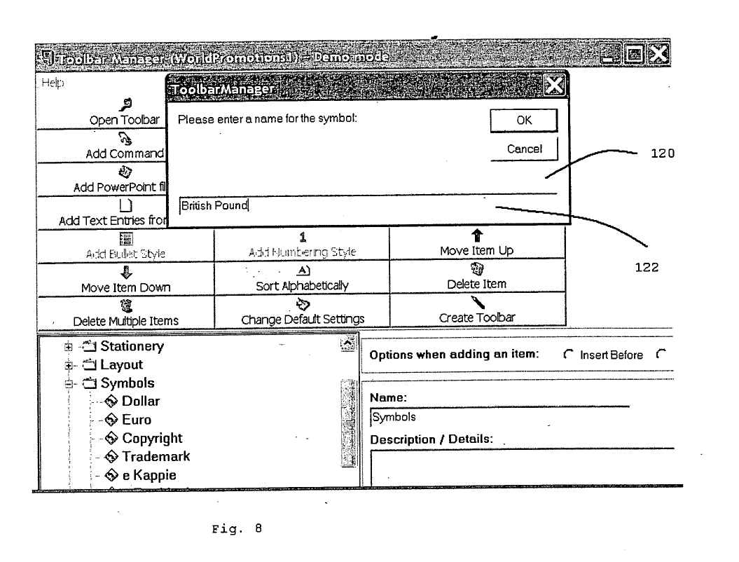

Referring now to FIGS. 5-8 there is illustrated a toolbar building application window 88 for the toolbar building application 38 shown in FIG. 2. The window 88 includes a plurality buttons 90, a display area. 92, and a fill-in form 94. Each button 90 corresponds to a particular toolbar building function, such as adding graphics, symbols, or numbering styles to a customized toolbar. The display area 92 allows the toolbar builder to view the toolbar directory structure 96 within the folder 52. The move buttons 98 are used to position additional toolbar indicia in a custom toolbar.

As shown in FIGS. 5-8, the toolbar amendment process is initiated by clicking on an open button 100. The open button 100 corresponds to the open toolbar file function. Clicking on the open button 100 actuates a pop-up menu 102 that displays a list 104 of files. The appropriate XML file 48 is selected for alteration or other similar amendment. Clicking on the add symbol button 106 actuates a pop-up window 108 that displays a plurality of drop down menus 110, toolbars 112, buttons 114, and fill-in forms 116. Clicking on the insert button 118 within the pop-up menu 108 actuates an additional pop-up window 120 that includes a fill-in form 122 for identifying a newly inserted symbol 124. Once the symbol 124 is inserted into the amended toolbar, the XML file 48 can be amended and saved in the data structure 40 with the save toolbar button 126.

The toolbar building application window 88 also includes a search button (not shown). Clicking on the search button actuates a query access process that queries the user for a filename, word, phrase, or similar query request to identify the document of interest. The toolbar building application 38 displays a list of relevant documents upon receiving the query input. The user clicks on the desired document or documents for editing, deleting, or similar modifications.

Referring now to FIGS. 1 and 3, the customized toolbar 24 also includes a search function. The search function is actuated by clicking on the toolbar help button 127. The customized toolbar 24 displays an MS Word form 64 having a textbox that provides query access to search strings. The textbox receives queries in the form of document names, phrases, words, or similar search strings.

The search function includes a limiting features that restricts the search to the toolbars 24, 28 or to specific toolbar buttons 26, 30. The toolbars 24, 28 display a list box (not shown) that lists all of the related documents that were found using the search function. The listbox displays button captions, path, document name, template name, and other similar information. The user selects the desired document or documents from the list.

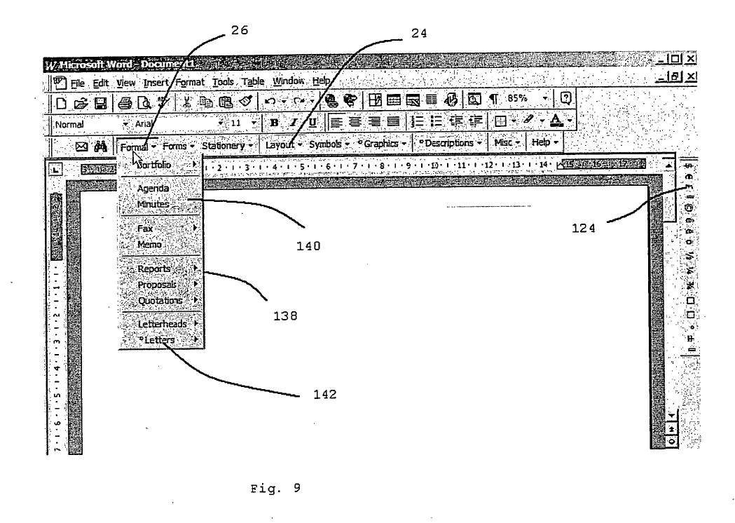

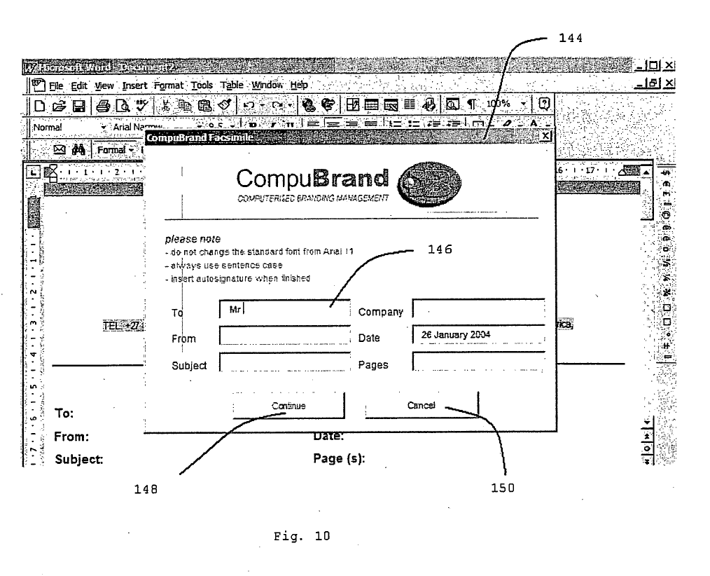

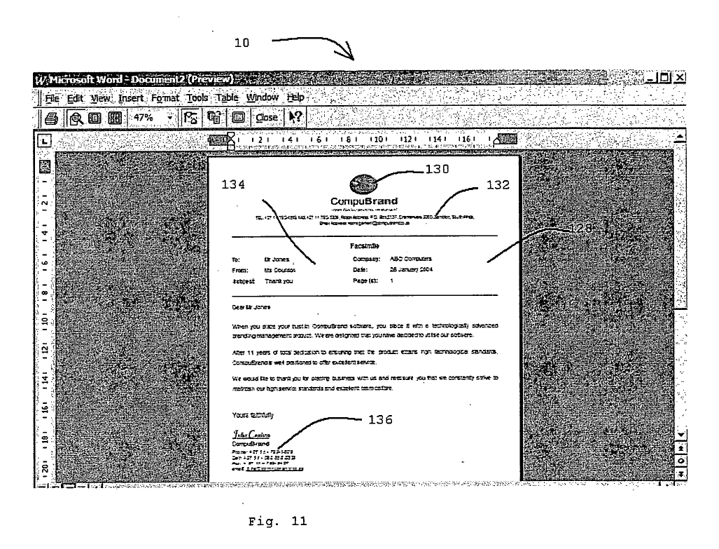

As shown in FIGS. 9-11, the customized toolbar 24 is used to create a standardized document 128. The standardized document 128 includes a standardized logo 130, letterhead 132, memo heading 134, and signature block 136. The document 128 is created by clicking one of the toolbar buttons 26 to reveal a drop down menu-138 having a function list 140 and selecting an item 142 corresponding to a document template.

Clicking on the item 142 initiates the display of a document template window 144. The document template window 144 includes a fill-in form 146 for receiving customized document information, continue button 148, and cancel button 150. Clicking on the continue button 148 executes the document template function to insert the customized document information into the standard document 128. Clicking on the cancel button 150 cancels the creation of the document 128. In the preferred embodiment, the document production function creates a standardized letter, report, fax, email communication, label, envelope, memoranda, or other similar corporate documentation, signature, graphic or stationary image.

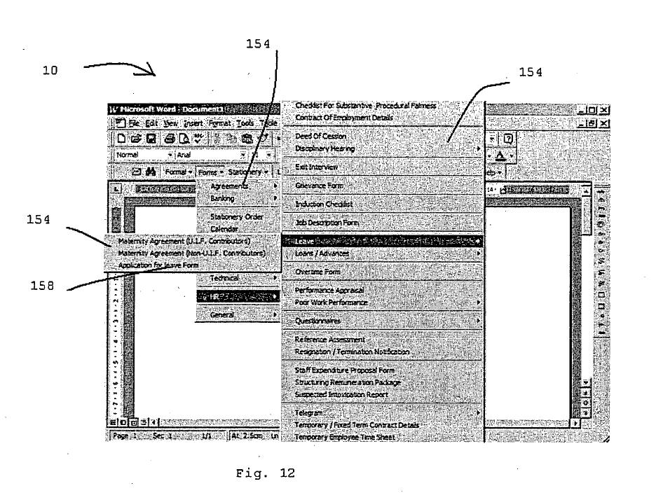

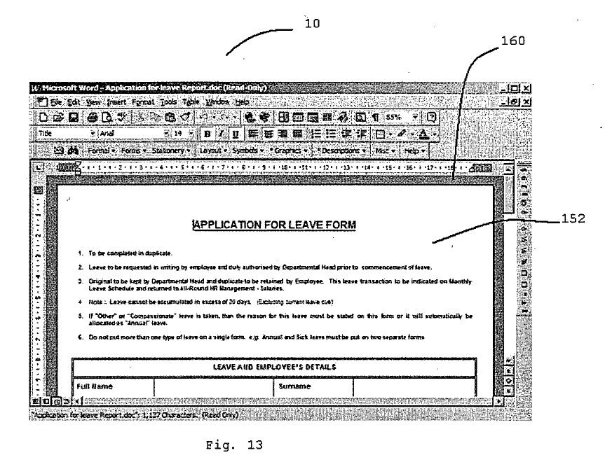

Referring now to FIGS. 12-13, the use of the customized toolbar 24 to distribute departmental forms 152 is shown. The department form 152 is accessed by clicking on a toolbar button 26 to reveal a plurality of drop down menus 154. Each menu 154 includes a function list 156 having individual items 158 that correspond to particular forms or groups of forms. Clicking on the item 158 that corresponds to the desired form 152 causes the function associated with the item 158 to insert the form 152 into an application window 160. In the preferred embodiment, the form distribution function is used to disseminate forms, maps, telephone directories, or other similar corporate documentation.

As shown in FIGS. 2-4, 12, and 13, the form distribution function allows clients 44 to synchronize their computers with one another. The hub 58 distributes the toolbar 24 to each client 44 so that the client 44 has access to the standardized letters, reports, faxes, email communication, labels, envelopes, memoranda, forms, maps, telephone directories, or other similar corporate documentation that are accessed using the toolbar 24 Since the toolbar 24 is available to the clients 44 when the client computers are not connected to the computer system 42, the toolbar 24 allows the clients 44 to synchronize their computers with the central hub 58.

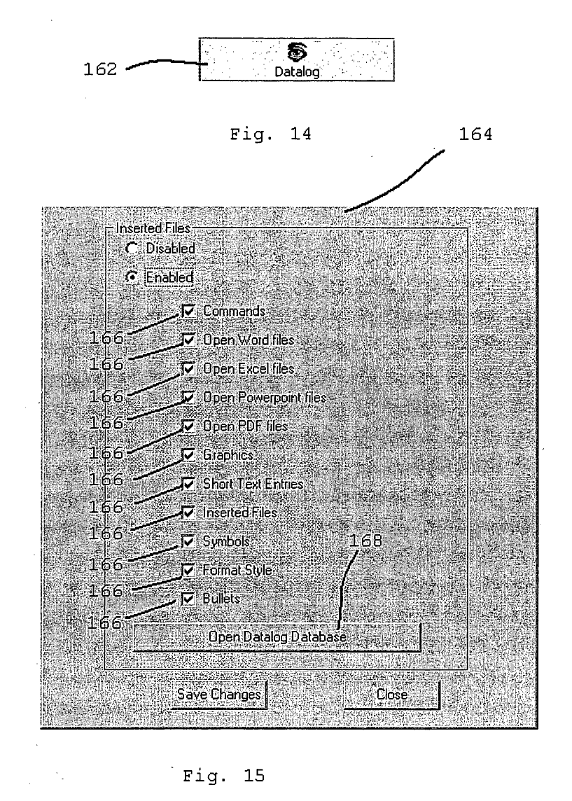

Referring now to FIGS. 14-15 there is shown a button 162 for actuating a datalog function within a toolbar administration application 62, which is shown in FIG. 3. The datalog function enables the toolbar administration application 62 to monitor the interaction between clients 44 and the toolbars 24, 28 shown in FIGS. 1-3. The datalog function provides the toolbar administration application 62 with the ability to monitor and to log toolbar usage of the clients 44. Clicking on the button 162 causes the toolbar administration application 62 to display a datalog function window 164. The datalog function cannot be used to monitor toolbar usage of users that are not connected to the Internet, an intranet, LAN, WAN, or other similar computer network, unless the toolbar administration application is installed on the user's computer or a computer that is linked to the user's computer.

As shown in FIG. 15, the datalog function is a feature that tracks toolbar usage. Each time a user clicks on a toolbar item that links to a toolbar feature, file, or function, the administration application 62 is logged to a Microsoft Access database. The user selects the feature, files, or functions for monitoring by selecting an appropriate box 166. The boxes 166 provide the ability to select commands, open word processor files, open spreadsheet files, open presentations, open documents, or other similar files for monitoring. The boxes 166 also provide the ability to monitor graphics, text, inserted files, symbols, formats, bullets, and other similar features or functions. The administration application 62 shown in FIG. 3 allows the administrator to specify the range of dates for monitoring.

TABLE 1
Logged Database Fields

| Database Fields | Type of Logged Information |
|---|---|
| Date | hh:mm:ss |
| Time | dd/mm/yyyy |
| UserID | The Windows logon name. |
| MachineID | Computer name as it displays on the network. |
| ToolbarName | This is suitable for companies that have |
| | more than one toolbar (e.g. departmental |
| | toolbars). Reports can be printed for |
| | specific toolbars. |
| ButtonName | The display name of the Toolbar button |
| | clicked on the CompuBrand Toolbar within |
| | Microsoft Word. |
| ButtonType | Eg. Command, Open Word, Open Excel, Open |
| | PowerPoint, Open PDF, Graphic, Short Text, |
| | Inserted Files, Symbols, Format Style, |
| | Bullets. |
| ButtonLink | If the button links to a document on the |
| | network, the filename and path will be added |
| | to this field. (only for Open Word, Open |
| | Excel, Open PowerPoint, Open PDF, Graphic, |
| | Inserted Files). |

The database is saved in an appropriate spreadsheet format, such as MS Access or Excel. The toolbar administration application 62 has the ability to run reports on toolbar usage. The application can produce custom or standard reports that display summarized versions of such information as usernames, dates, times, and all toolbar functions performed with the customized toolbars 24, 28 shown in FIG. 1 within the specified time period range. The types of database fields that are logged by the datalog function are shown in Table 1.

The toolbar administration application 62 also has the ability to monitor time savings for conversion into cost savings reports. The application 62 has the ability to modify queries, reports and forms to suit individual company needs. The database is saved in a file within a folder path identified with a \masterfiles\logs hierarchy. The database is password protected with the password being provided upon registration. In the preferred embodiment, the database is saved in MS Access 97 format and has the ability to be converted to any higher version of Access.

According to the provisions of the patent statutes, I have explained the principle, preferred construction and mode of operation of my invention and have illustrated and described what I now consider to represent its best embodiments. However, it should be understood that, within the scope of the appended claims, the invention may be practiced otherwise than as specifically illustrated and described.

1. A system for customizing a software application comprising:
a customizable toolbar including a source code program having a plurality of means for processing data and a folder for storing said data processing means,
a hub having a file for storing the customizable toolbar and a memory storage device for storing said file thereon,
said hub connected to a plurality of remote clients,
each remote client having a software application residing thereon,
each software application having the ability to interface with said toolbar, and
said hub distributing said toolbar to the plurality of remote clients so that each of said client software applications accesses said toolbar.

2. A system as set forth in claim 1 which includes:
security means for restricting access to said toolbar residing on said central unit memory device.

3. A system as set forth in claim 2 in which:
said security means includes a control program.

4. A system as set forth in claim 1 in which:
said data processing means includes a plurality of icons for controlling said client software applications.

5. A system as set forth in claim 1 in which:
said data processing means includes a plurality of prompts for controlling said client software applications.

6. A system as set forth in claim 1 in which:
said data processing means produces templates.

7. A system as set forth in claim 1 in which:
said data processing means produces forms.

8. A system as set forth in claim 1 in which:
said data processing means includes macro symbols for executing macros.

9. A system as set forth in claim 1 in which:
said data processing means produces auto signatures.

10. A system as set forth in claim 1 in which:
said file includes an XML file.

11. A system as set forth in claim 1 in which:
said hub includes a computer.

12. A system as set forth in claim 1 in which:
said hub includes a server.

13. A system as set forth in claim 1 which includes:
a toolbar administration application for monitoring said toolbar.

14. A system as set forth in claim 13 in which:
said hub includes said toolbar administration application residing thereon.

15. A system as set forth in claim 13 in which:
said toolbar administration application residing thereon includes a datalog function for monitoring interaction between said toolbar and said client software applications.

16. A system as set forth in claim 1 in which:
at least one of the remote clients includes a computer having a memory device for storing said toolbar, a display device for displaying said toolbar, and an interface device for facilitating access to said toolbar.

17. A system as set forth in claim 1 in which:
said remote client computer includes a laptop computer.

18. A system as set forth in claim 1 in which:
said remote client computer includes a PC.

19. A system as set forth in claim 1 which includes:
a network for connecting said hub to the remote clients.

20. A system as set forth in claim 1 in which:
said hub automatically distributes said toolbar to said plurality of remote clients upon execution of said client software applications.

21. A system as set forth in claim 1 in which:
said client software application includes a word processing program.

22. A method for providing custom toolbars to remote clients comprising:
accessing a toolbar building application for converting standard toolbar into custom toolbars,
executing the toolbar building application to create a custom toolbar for storing in a file residing on a control computer,
connecting the control computer to a client computer having a software application for utilizing the custom toolbar residing thereon,
transferring the custom toolbar from the control computer to the client computer so that the software application includes the custom toolbar, and
executing the software application to display the custom toolbar on the client computer so that software application utilizes the custom toolbar.

23. A method as set forth in claim 22 which includes:
transferring the custom toolbar from a toolbar creation computer to the control computer.

24. A method as set forth in claim 22 which includes:
protecting the toolbar building application with a password protection routine.

25. A method as set forth in claim 22 which includes:
restricting access to the central computer with security protection means.

26. A method as set forth in claim 25 which includes:
protecting the central computer with a password protection routine.

27. A method as set forth in claim 25 which includes:
communicating a key code to the security protection means to provide selective access to the central computer.

28. A method as set forth in claim 22 which includes:
displaying a fill-in form to acquire information to build the custom toolbar.

29. A method as set forth in claim 22 which includes the step of:
automatically transferring the custom toolbar from the control computer to the client computer upon execution of the client computer software application that utilizes the custom toolbar.

30. A method as set forth in claim 22 which includes:
monitoring interaction between the custom toolbar and the client computer software application residing on the client computer.

31. A method as set forth in claim 22 which includes:
logging custom toolbar usage on the client computer.

32. A method for building a customized toolbar for providing to remote users comprising:
accessing to a control computer having a memory device to execute a toolbar building program and a standard toolbar residing in the control computer memory device,
displaying a builder form to receive input to define a function list for amending the standard toolbar to form a customized toolbar,
transferring the function list from the builder form to the toolbar building program to interface the function list with the toolbar building program,
executing the toolbar building program to convert the function list and standard toolbar into the customized toolbar, and
storing the customized toolbar in the control computer memory device.

33. A method as set forth in claim 32 which includes:
transferring the customized toolbar to a central server.

34. A method as set forth in claim 33 which includes:
connecting the central server to a plurality of clients having software applications residing thereon, and
distributing the customized toolbar to each of the clients so that the client software applications interface with the customized toolbar.

35. A method as set forth in claim 34 which includes:
protecting the central server with security means.

36. A method as set forth in claim 32 which includes:
storing the customizable toolbar in an XML file.

37. A method as set forth in claim 32 which includes:
connecting the control computer to at least one client computer having a primary software application and plurality of secondary software applications residing thereon, and
copying the customized toolbar to the client computer so that the primary software application utilizes the customized toolbar to execute the secondary software applications.

38. A method as set forth in claim 32 which includes:
providing a password to the control computer to access the toolbar building program and the standard toolbar residing in the control computer memory device.
